(19) United States
(12) Patent Application Publication
(10) Pub. No.: US 2007/0239690 A1
(43) Pub. Date: Oct. 11, 2007

(54) Document data processing device, document data list provision method and computer program product

(75) Inventor: Hideyuki Matsuda, Suita-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/607,061

(22) Filed: Dec. 1, 2006

(30) Foreign Application Priority Data
Mar. 22, 2006 (JP) 2006-079553

(51) Int. Cl. G06F 17/30; G06F 3/12; G06F 7/00; G06F 17/00

(52) U.S. Cl. 707/3; 707/1; 707/104.1; 707/5; 358/1.15; 707/100

(57) ABSTRACT

A method and device is provided which allows users to easily confirm which document data is saved even in an environment where document data are distributed and saved on plural devices. An image forming device is provided with a box management portion for managing a box where document data is saved, a document list request receiving portion for receiving a request for a list of the document data, a document list collection portion for collecting, based on the received request, the list of the document data saved in the box as well as the document data saved in other image forming device and a document list transmitting portion for sending the collected list to the user who made the request.

This application is based on Japanese patent application No. 2006-079553 filed on Mar. 22, 2006, the contents of which are hereby incorporated by reference.

### BACKGROUND OF THE INVENTION

1. Field of the Invention

The present invention relates to a device, such as an MFP, for performing processing relating to document data, a method for providing a list of document data and others.

2. Description of the Related Art

Intranets come into widespread use in organizations such as government offices, companies and schools. In general, a form called a “client/server system” or a “C/S” is often used as the form of a system in which an intranet is used to manage document data, e.g., files of text, diagrams, photographs or images, used by users. According to such a form, a high-performance server centrally manages the document data. A user operates a client, namely, a terminal such as a personal computer to access the server, and thereby to use the document data.

In recent years, however, performance of devices constituting an intranet has improved, allowing the device, which mainly functioned as a client before, to be used as a server. For example, image forming devices called Multi Function Peripherals (MFPs) or multifunction devices are provided with a high-speed CPU, a high-capacity hard disk drive, a high-speed network interface and others. Further, server applications for the image forming devices are provided and a file server function called, for example, a “box function” is implemented.

Besides, there are proposed network-compliant devices in Japanese unexamined patent publication Nos. 11-55493, 2003-67279, 2003-338889 and 2005-94522. According to the first publication, facsimile equipment is connected to a PC and is adapted to conduct facsimile communication through memory reception and control from the PC. A data transfer available time to the PC is registered and a file of memory reception is transferred only for the registered data transfer available time zone to the PC. Alternatively, ON/OFF of the PC power supply is judged from a physical interface to the PC and the file of memory reception is transferred to the PC only when the PC power supply is active.

The second publication discloses the technology stated below relating to a mirror server. A function to adapt to become a mirror server at the request of an origin server for dynamic mirroring is added to an arbitrary node in a network. When the origin server performs a dynamic mirroring of the contents, an adapted mirror node detection means detects an adapted mirror node in the network and determines the mirroring destination by a dynamic mirroring destination determination means. A dynamic mirroring request means makes a dynamic mirroring request to the selected adapted mirror node and, when the request is accepted, the mirror contents are transferred by a dynamic mirroring means. The adapted mirror node stores the received mirror contents in a mirror contents storage part and functions as a mirror server.

An image processing system according to the third publication includes a data acquisition unit for acquiring image information, a storage unit for making the image information correspond to time information to automatically store the image information regardless of the presence/absence of explicit storage instructions from a user and making it impossible to change the time information associated with the image information, and a processor which performs a temporary storage processing process that temporarily stores the image information in a nonvolatile memory before storing the image information in the storage unit, performs a shutdown process that is started in response to a power-off command, sends an end request to the temporary storage processing process and disconnects the power supply after waiting until the temporary storage processing process is finished, and performs control such that the temporary storage processing process stores all unstored image information and is then finished in response to the end request.

In a facsimile device according to the fourth publication, a copy control unit includes a CPU for controlling a copy function and the whole of the facsimile device, a ROM for storing a program, a RAM for accumulating information, a workRAM for processing data, a compression and expansion unit for compressing and expanding image data, and a large-capacity memory. A communication control unit includes a ROM and a FROM for storing a program, a RAM for accumulating information, a workRAM for processing data, a FAX image data processing unit for storing FAX image data in each memory or carrying out copy operation among the memories, a FAX image accumulating memory for accumulating the received image data, and an exterior accumulating device. The RAMs for accumulating information are backed up by a primary battery and the like so that the contents are held when a power supply is turned OFF.

Meanwhile, various devices constituting an intranet are provided with a server function as described above, so that users sometimes save their document data on some devices with the document data being distributed. The users, in some cases, intend to confirm which document data are saved in these devices.

In the case, however, where document data are distributed and saved on devices making up an intranet, according to conventional technologies, users are required to access to each of the devices to confirm document data saved therein, which is burdensome operation.

### SUMMARY OF THE INVENTION

The present invention is directed to solve the problems pointed out above, and therefore, an object of the present invention is to provide a method and device, even in an environment where document data are distributed and saved on plural devices, for allowing users to easily confirm which document data are saved.

A document data processing device according to one aspect of the present invention is a document data processing device performing processing related to document data. The document data processing device includes a data saving portion for saving the document data, a list request receiving portion for receiving a request for a list of the document data, and a list providing portion for performing list provision processing for providing a user who has made the request with a first list and a second list based on the request received by the list request receiving portion, the first list being a list of the document data saved in the data saving portion and the second list being a list of document data saved in other document data processing device.

Preferably, the list providing portion performs the list provision processing by receiving, from the other document data processing device, information of the document data saved in the other document data processing device and by sending the first list and the second list including the information thus received to the user who has made the request.

Further, the list providing portion performs the list provision processing by sending the first list from the document data processing device itself to the user who has made the request and by letting the other document data processing device send the second list to the user who has made the request.

Moreover, the data saving portion is provided with a storage area for saving the document data for each user, and the list providing portion performs the list provision processing so as to provide the user who has made the request with the first list of the document data saved in the storage area of the user who has made the request and the second list of document data saved in a storage area, provided in the other document data processing device, of the user who has made the request.

The document data processing device may have the following configuration. The document data processing device includes a data saving portion for saving the document data of a first user who is a user primarily using the document data processing device, a list request receiving portion for receiving a request for a list of the document data from the first user, a list providing portion for performing list provision processing for providing the first user who has made the request with a first list and a second list based on the request received by the list request receiving portion, the first list being a list of the document data saved in the data saving portion and the second list being a list of document data saved in other document data processing device, a list request receiving proxy portion for receiving the request from a second user who is a user primarily using other document data processing device in place of the other document data processing device, and a list provision proxy portion for performing list provision proxy processing, in place of the other document data processing device primarily used by the second user who has made the request, for providing the second user with a third list and a fourth list based on the request received by the list request receiving proxy portion, the third list being a list of the document data saved in the other document data processing device and the fourth list being a list of document data saved in a document data processing device except for the other document data processing device.

Further, the document data processing device also includes an other device saved data list obtaining portion for obtaining, from the other document data processing device that the second user uses primarily, an other device saved data list that is a list of the document data saved in the other document data processing device, wherein the list provision proxy portion performs the list provision proxy processing based on the other device saved data list of the other document data processing device primarily used by the second user who has made the request.

The above-described structure allows users to easily confirm which document data are saved even in an environment where document data are distributed and saved on plural devices.

According to one aspect of the present invention, users can easily confirm document data saved in each device even if a device primarily used by the user is turned off.

These and other characteristics and objects of the present invention will become more apparent by the following descriptions of preferred embodiments with reference to drawings.

### BRIEF DESCRIPTION OF THE DRAWINGS

FIG. 1 is a diagram showing an example of the entire configuration of a document data list browsing system.

FIG. 2 is a diagram showing an example of the entire configuration of an intranet.

FIG. 3 is a diagram showing an example of a hardware configuration of an image forming device.

FIG. 4 is a diagram showing an example of a functional configuration of the image forming device.

FIG. 5 shows an example of electronic mail accounts set in an electronic mail server.

FIG. 6 is a diagram showing an example of a configuration of a home MFP processing portion.

FIG. 7 is a flowchart illustrating a flow example of document list creation and transmission processing.

FIG. 8 shows an example of a document data list screen.

FIG. 9 is a diagram showing an example of a configuration of a mirroring MFP processing portion.

FIG. 10 is a flowchart showing a flow example of mirroring request processing and mirroring request receiving processing.

FIG. 11 is a flowchart showing a flow example of document list creation and transmission proxy processing.

FIG. 12 is a flowchart showing a flow example of unmirroring request processing and unmirroring processing.

FIG. 13 is a diagram showing an example of a configuration of a segment master processing portion.

FIG. 14 is a flowchart illustrating a flow example of document information obtaining processing, segment master processing and document information provision processing.

FIG. 15 is a flowchart showing a flow example of the entire processing in the image forming device.

FIG. 16 is a flowchart illustrating a flow example of mail handling processing.

FIG. 17 is a flowchart showing a flow example of mirroring processing.

FIG. 18 is a flowchart illustrating a flow example of mail handling proxy processing.

### DESCRIPTION OF THE PREFERRED EMBODIMENTS

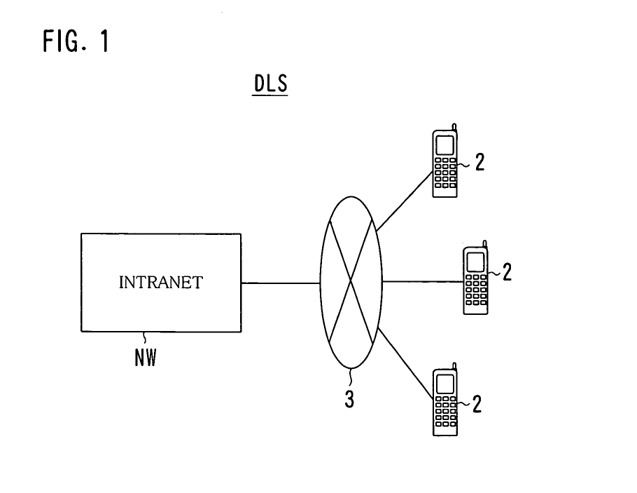

A description is provided, with reference to FIGS. 1-5, of the entire configuration of a document data list browsing system DLS, the entire configuration of an intranet NW, and a hardware configuration of an image forming device 1.

Referring to FIG. 1, the document data list browsing system DLS includes the intranet NW, terminals 2 and a communications line 3. Users can save their document data in image forming devices included in the intranet NW of the document data list browsing system DLS. The users can also operate the terminals 2 to browse a list of the document data saved in the intranet NW.

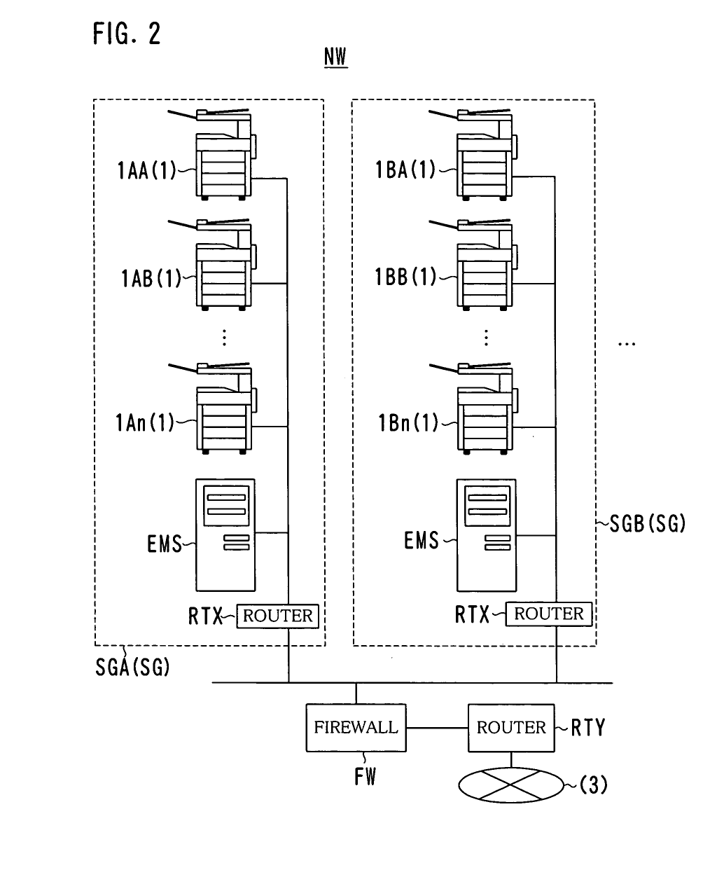

The intranet NW is a network system for an organization such as a government office, a company or a school. In some cases, the intranet NW is constituted by one segment. In other cases, it is constituted by plural segments interconnected by a communications line. In this embodiment, as shown in FIG. 2, a description is provided, by way of example, of the intranet NW including plural segments SGA, SGB . . . and the like. Hereinafter, these segments SGA, SGB . . . may be collectively referred to as a “segment SG”.

The intranet NW includes, in addition to the segment SG, equipment such as a router RTY for connecting to an external network like the Internet, and a firewall FW for preventing unauthorized access from external networks.

Thus, the entire hardware configuration itself of the intranet NW in this embodiment is basically the same as those of conventional intranets.

Referring to FIG. 2, the segment SG includes an electronic mail server EMS, plural image forming devices 1 and the router RTX. Each of the image forming devices 1 is a processing device in which various functions such as a copy function, a scanner function, a fax function, a network printing function, a document server function and an Internet fax function are integrated. In general, the image forming devices 1 are sometimes called multifunction devices or Multi Function Peripherals (MFPs), for example.

The “network printing” function is a function to print an image on paper by receiving image data from a personal computer via a communications line. This function is sometimes called a “network printer function” or a “PC print function”, for example.

The “document server” function is a function to provide each user with a storage area called, for example, a “box” or a “personal box” corresponding to a folder or directory in a personal computer, thereby enabling the user to store document data such as an image file in user's own storage area. This function is sometimes called a “box function”.

The “Internet fax” function is a function to receive an electronic mail transmitted by the other party as fax data or to receive fax data transmitted by the other party as an electronic mail. Stated differently, the Internet fax function is a communications function between an electronic mail terminal and a fax terminal. This function is sometimes called an “iFAX”.

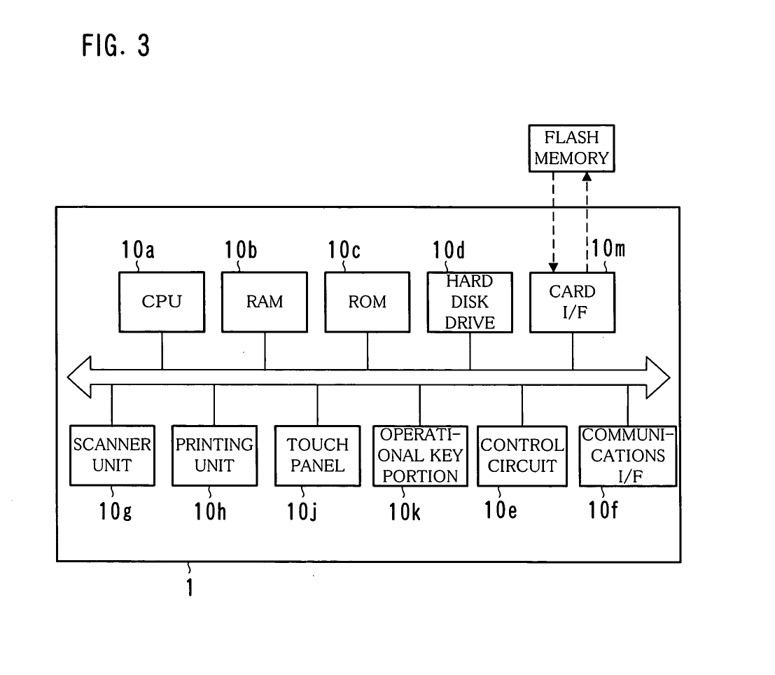

As shown in FIG. 3, the image forming device 1 includes a CPU 10a, a RAM 10b, a ROM 10c, a hard disk drive 10d, a control circuit 10e, a communications interface 10f, a scanner unit 10g, a printing unit 10h, a touch panel 10j, an operational key portion 10k and a card interface 10m.

The control circuit 10e is a circuit for controlling the hard disk drive 10d, the communications interface 10f, the scanner unit 10g, the printing unit 10h, the touch panel 10j, the operational key portion 10k, the card interface 10m and others.

The communications interface 10f is a modem for performing data communications with an external fax terminal and a Network Interface Card (NIC) for performing data communications with other image forming device 1, the electronic mail server EMS and the like.

The operational key portion 10k is made up of, for example, a numeric keypad and a cursor key, and is used by a user to provide commands, such as a command to start execution of processing, to the image forming device 1 and to specify processing conditions and various other matters. The touch panel 10j displays a screen for providing the user with messages or instructions, a screen for the user to enter desired types of processing and processing conditions, and a screen indicating results of the processing executed in the CPU 10a, for example. In addition, the user can provide commands to the image forming device 1 or specify processing conditions by touching predetermined positions on the touch panel. Thus, the printing unit 10h and the operational key portion 10k serve as user interfaces for the user operating the image forming device 1.

The scanner unit 10g optically reads document images such as text, numerical expressions, symbols, photographs, diagrams or illustrations that are depicted on a sheet of paper, and generates image data.

The printing unit 10h forms an image based on the image data obtained with the scanner unit 10g or image data transmitted from a personal computer or the like, and prints the image on a sheet of paper by electrophotography.

The card interface 10m is an interface for reading data out of a removable memory such as a flash memory and for writing data into the removable memory.

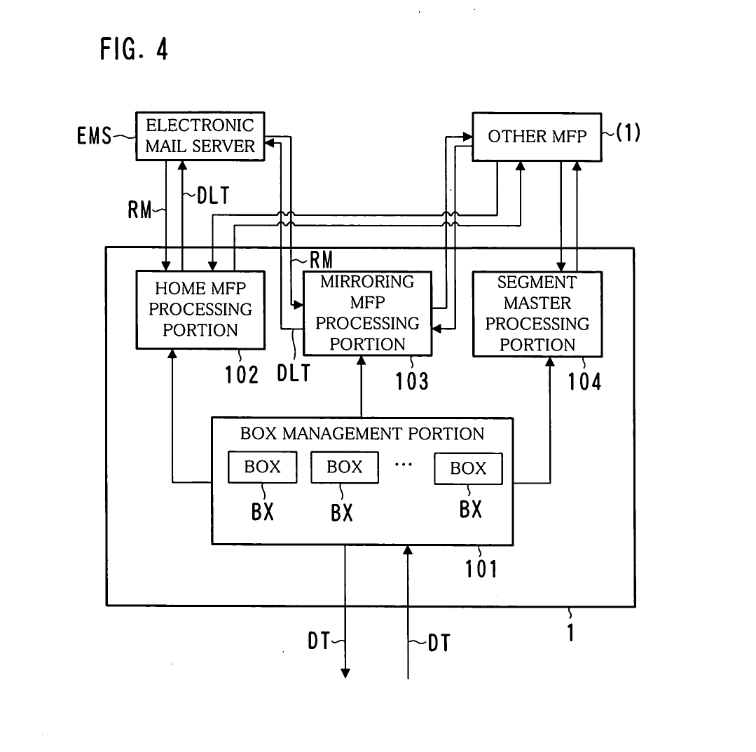

On the hard disk drive 10d is installed a program and data for implementing functions of a box management portion 101, a home MFP processing portion 102, a mirroring MFP processing portion 103 and a segment master processing portion 104, all of which are shown in FIG. 4. The program and data are read into the RAM 10b as needed, and the program is executed by the CPU 10a. Alternatively, some or all of the functions shown in FIG. 4 may be implemented with the control circuit 10e.

Hereinafter, among the image forming devices 1 included in the intranet NW, the image forming devices 1 belonging to the segment SGA are sometimes referred to as an “image forming device 1AA”, an “image forming device 1AB”, an “image forming device 1AC” . . . , while the image forming devices 1 belonging to the segment SGB are sometimes referred to as an “image forming device 1BA”, an “image forming device 1BB”, an “image forming device 1BC” . . . , and the like. In addition, each of the image forming devices 1 is given a device name such as “MFP-1AA”, “MFP-1AB” or “MFP-1BA” by using the reference symbol.

Members belonging to an organization into which the intranet NW is introduced can freely use any image forming devices 1 in the intranet NW. Each of the members, however, is required to register, in advance, any one of the image forming devices 1 as a home MFP. Herein, the “home MFP” means an image forming device (MFP) that is primarily used by the member himself/herself. The members belonging to the organization where the intranet NW is introduced are hereinafter referred to as “user(s) UR”. Each of the users UR may be referred to as a “user UR1”, a “user UR2”, a “user UR3”, . . . in order to distinguish the users UR from one another.

The electronic mail server EMS manages electronic mail accounts, an out-box and an in-box for each of the electronic mail accounts and others. The existing electronic mail server can be used as the electronic mail server EMS. In addition, an electronic mail address shall be also used as an account name of the electronic mail account.

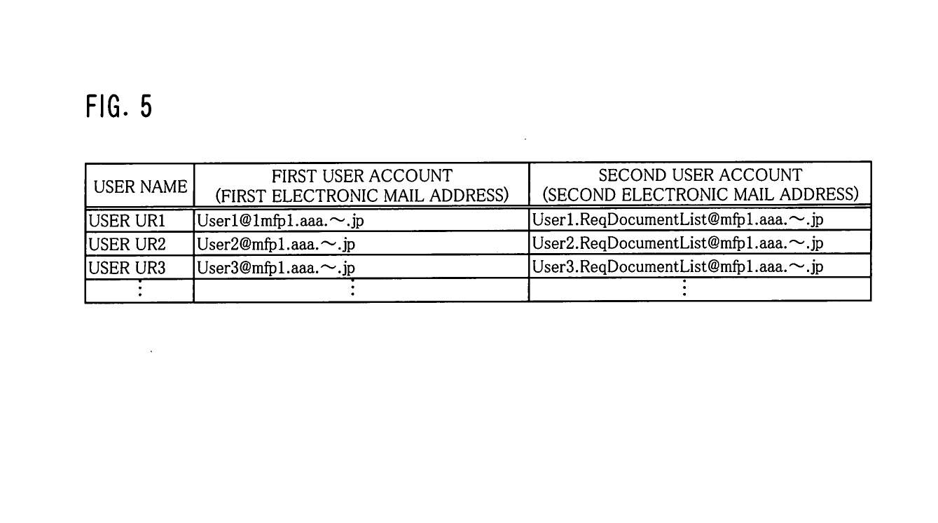

As shown in FIG. 5, in the electronic mail server EMS is set a set of a first electronic mail account and a second electronic mail account for each of the users UR who register as a home MFP any one of the image forming devices 1 in a segment SG to which the electronic mail server EMS belongs. The first electronic mail account is one used for iFAX. The second electronic mail account is one used for receiving a document list request that will be described later. Hereinafter, an electronic mail address of the first electronic mail account and an electronic mail address of the second electronic mail account are referred to as a “first electronic mail address” and a “second electronic mail address”, respectively.

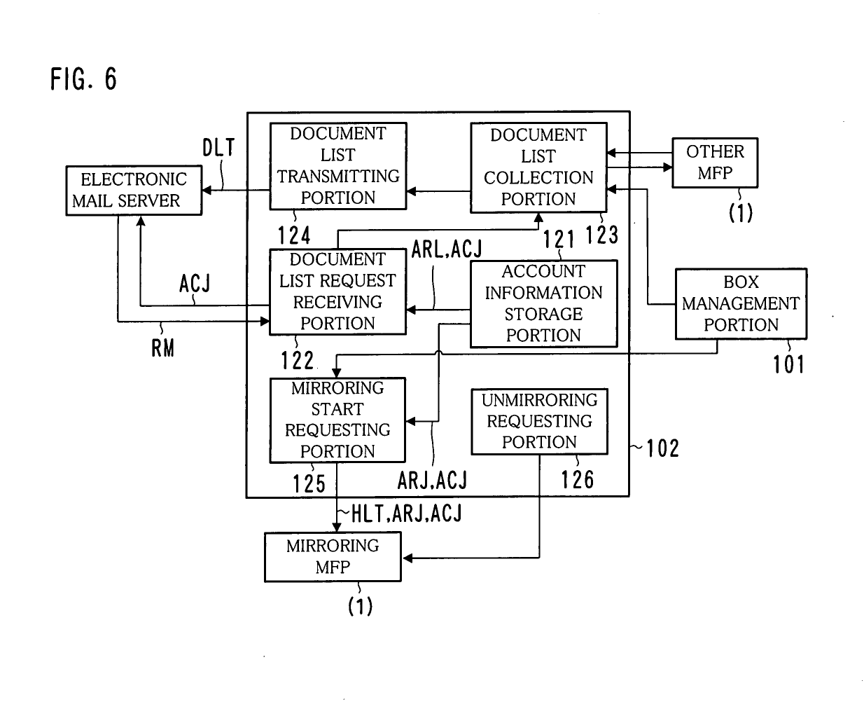

Next, a description is provided, based on FIGS. 6-14, of processing contents of each of the portions included in the image forming device 1 shown in FIG. 4. The box management portion 101 performs processing for securing a box area in the hard disk drive 10d for each of the users UR who register that image forming device 1 as a home MFP to manage each box. For example, the box management portion 101 performs processing for newly saving document data in a box, retrieving document data from a box based on a request from a user UR and updating or deleting document data saved in a box. Further, when an inquiry is made concerning attribute information, e.g., a data name, a path name of a box BX as a storage location, a data size or a data type, of document data saved in the box BX, the box management portion 101 performs processing for making a reply to the inquiry source.

Hereinafter, a box managed by the box management portion 101 is referred to as a “box BX” and document data saved in the box BX is referred to as “document data DT”. A user can save his/her own document data DT in his/her box BX.

A case arises where the box management portion 101 secures an area for a box BX of a user UR who registers other image forming device 1 as a home MFP to manage the box BX. More specifically, document data DT, e.g., image data obtained by scanning an original document, that is obtained by a user UR using any image forming device 1 in the document data list browsing system DLS, is usually saved in a box BX managed in a home MFP of the user UR. For example, even if the user UR operates an image forming device 1 other than the home MFP to obtain document data DT, the document data DT are transferred to the home MFP and is saved in the box BX of the user UR in the home MFP. When the home MFP, however, leaves the intranet NW due to the reason that the power supply is turned off or other reason, the document data DT cannot be transferred. In such a case, a box BX of the user UR is provided in the image forming device 1 that is not the home MFP, and the document data DT are saved in the box BX thereof.

The box BX has a path name such as \\MFP-1AA\User1 or \\MFP-1BD\User3. The document data are saved in the box BX on a file basis and has a file name (a data name, a document name) like “Document1.pdf” or “Document1.tif”.

The home MFP processing portion 102 includes, as shown in FIG. 6, an account information storage portion 121, a document list request receiving portion 122, a document list collection portion 123, a document list transmitting portion 124, a mirroring start requesting portion 125 and an unmirroring requesting portion 126. The home MFP processing portion 102 performs processing necessary for the image forming device 1 to function as a home MFP. In particular, in this embodiment, the home MFP processing portion 102 performs processing for providing each user UR using that image forming device 1 as a home MFP with a list of document data DT saved in a box BX of the user UR. The list of the document data DT is hereinafter referred to as a “document data list DLT”. In addition, the users UR who use the image forming device 1 as a home MFP are sometimes referred to as “home user(s) URH”. Each of the home users URH may be referred to as a “home user URH1”, a “home user URH2”, . . . or the like in order to distinguish the home users URH from one another.

The account information storage portion 121 stores account information ACJ indicating an account name of the second electronic mail account (the second electronic mail address, because an electronic mail address is used also as the account name of the electronic mail account in this embodiment as described above) and a password for each user UR using that image forming device 1 as a home MFP, i.e., for each home user URH. The account information storage portion 121 also stores an address list ARL specifying the first electronic mail address of each home user URH and an electronic mail address set in the terminal 2 (hereinafter referred to as a “terminal electronic mail address).

The document list request receiving portion 122 performs processing for receiving a request for the document data list DLT from a home user URH. The processing is performed according to the following procedure.

The home user URH uses his/her terminal 2 to create an electronic mail for request (hereinafter referred to as a “list request mail RM”). The home user URH uses a terminal electronic mail address, i.e., specifies the terminal electronic mail address as a sender, and transmits the list request mail RM thus created to his/her second electronic mail address. Responding to this, the electronic mail server EMS managing the second electronic mail account of the second electronic mail address receives the list request mail RM to store the received mail RM in an in-box corresponding to the second electronic mail account.

The document list request receiving portion 122 accesses the electronic mail server EMS at regular intervals to check whether or not a list request mail RM is delivered to the second electronic mail address of the home user URH of that image forming device 1 itself. When the list request mail RM is received, the document list request receiving portion 122 obtains the same. The account information ACJ stored in the account information storage portion 121 is used in order to check and obtain the list request mail RM.

The document list request receiving portion 122 accepts the obtained list request mail RM as a request from the home user URH having the second electronic mail address specified in the destination of the obtained mail RM. The document list request receiving portion 122 instructs the document list collection portion 123 and the document list transmitting portion 124 to perform processing for responding to the request. When a sender (a transmission source) of the list request mail RM is not a home user URH for that image forming device 1, the request regarding the list request mail RM is denied and a message indicating that the request cannot be accepted is sent in response to the list request mail RM.

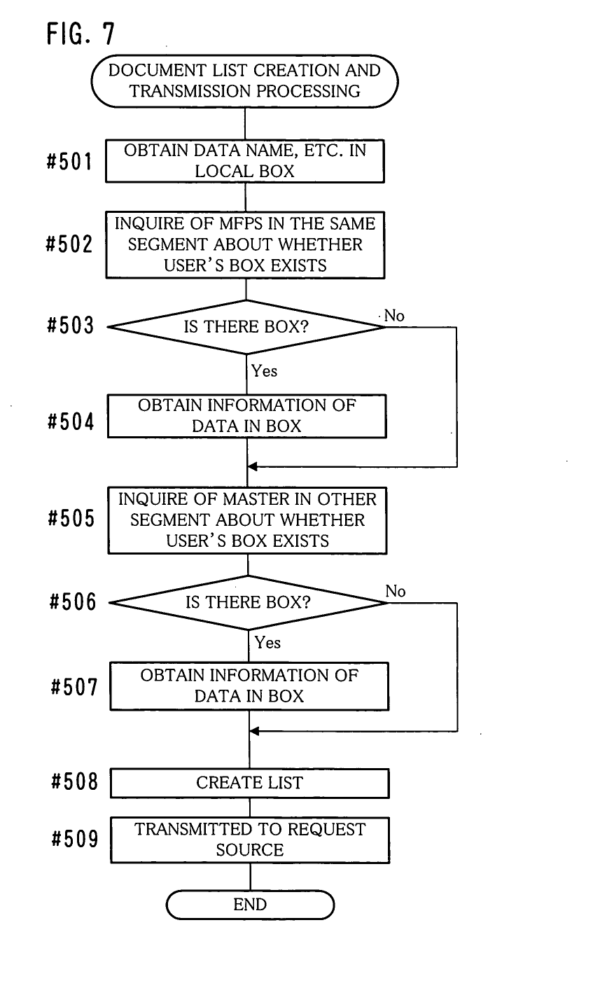

The document list collection portion 123 and the document list transmitting portion 124 perform, in accordance with the instructions from the document list request receiving portion 122, processing for creating a document data list DLT for the home user URH regarding the sender of the list request mail RM and transmitting to the sender the created document data list DLT according to the procedure shown in FIG. 7.

Suppose, for example, that the document list request receiving portion 122 has received the list request mail RM from the home user URH1.

The document list collection portion 123 refers to a box BX, which is managed by the box management portion 101 of that image forming device 1, i.e., the local box BX of the home user URH1 who is a sender of the list request mail RM. Then, the document list collection portion 123 obtains a list of information of attribute such as a data name, a data size and a data type of each piece of document data DT saved in the box BX (#501).

In parallel with this or before or after, the document list collection portion 123 accesses other image forming device 1 belonging to the same segment SG and inquires about whether or not a box BX of the home user URH1 exists (#502). Responding to this, the box management portion 101 of the image forming device 1 that has received the inquiry checks whether or not it manages the box BX of the home user URH1 and makes a reply. When receiving a reply that the box BX of the home user URH1 is managed (Yes in #503), the document list collection portion 123 makes a request for attribute information of document data DT saved in the box BX and obtains the same (#504).

In parallel with the processing in Step #501 and the processing from Steps #502 to #504 or before or after the same, the document list collection portion 123 accesses an image forming device 1 functioning as a segment master among image forming devices 1 belonging to other segment SG. Then, the document list collection portion 123 inquires about whether or not a box BX of the home user URH1 exists in any of the image forming devices 1 belonging to the other segment SG (#505). This inquiry may be made by sending an electronic mail to the segment master.

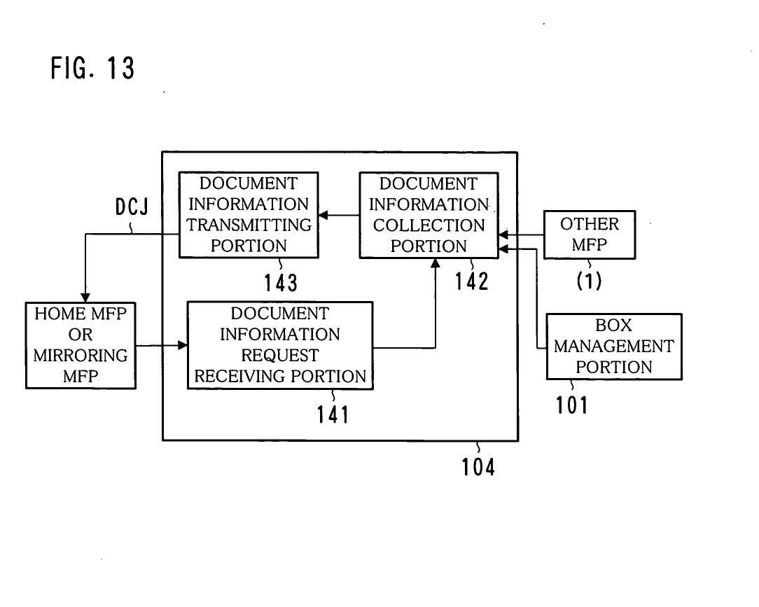

Herein, the “segment master” means a representative image forming device 1 among image forming devices 1 belonging to a certain segment SG. The segment master that has received the inquiry checks whether or not the segment master itself manages the box BX of the home user URH1 and also checks whether or not the box BX is managed by other image forming device 1 belonging to the same segment SG. Then, the segment master makes a reply. The processing in the segment master will be detailed later with reference to FIG. 13 and others.

When receiving a reply that the box BX of the home user URH1 is managed (Yes in #506), the document list collection portion 123 makes a request to the image forming device 1 as the segment master for attribute information of document data DT saved in the box BX and obtains the same (#507).

The attribute information of the document data DT obtained in Steps #501, #504 and #507 is organized. Thereby, a document data list DLT is created that indicates the document data DT saved in the box BX of the home user URH1 managed by the respective image forming devices 1 in the document data list browsing system DLS (#508).

The document list transmitting portion 124 transmits an electronic mail to which the created document data list DLT is attached (hereinafter referred to as a “list attached mail LM”) to a terminal electronic mail address of the home user URH1 who is the request source (#509).

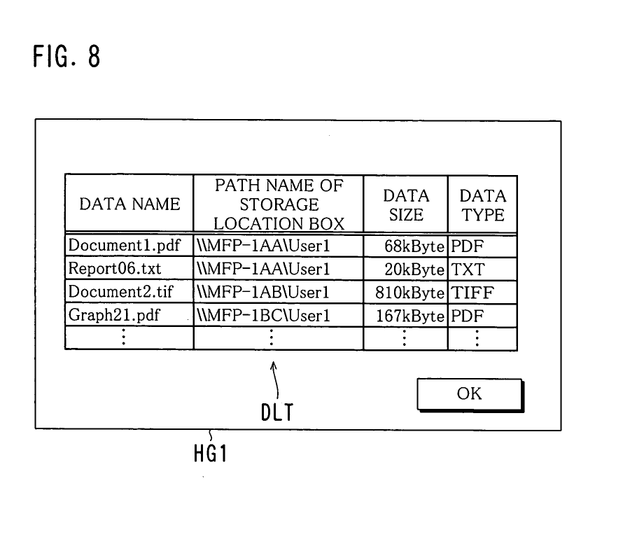

The home user URH1 uses his/her terminal 2 to receive and open the list attached mail LM. Then, as shown in FIG. 8, on a display of the terminal 2 is displayed the document data list screen HG1 in which the document data list DLT attached to the list attached mail LM is placed.

Referring back to FIG. 6, in the case where an image forming device 1 leaves the intranet NW, for example, before the power supply of the image forming device 1 is turned off or the image forming device 1 stops the network function, the mirroring start requesting portion 125 of that image forming device 1 performs processing for requesting other image forming device 1 to carry out, as a proxy, the above-described processing for providing a user with the document data list DLT. Hereinafter, in this embodiment, taking over the processing of providing a user with the document data list DLT is referred to as “mirroring”. Note, however, that this “mirroring” differs from “mirroring” that means RAIDI in the field of storage technology.

When the image forming device 1 itself rejoins the intranet NW, the unmirroring requesting portion 126 requests the other image forming device 1 performing the mirroring to stop (cancel) the mirroring. Herein, “unmirroring” means quitting mirroring.

The detailed processing of the mirroring start requesting portion 125 and the unmirroring requesting portion 126 is described along with that of the mirroring MFP processing portion 103 mentioned below.

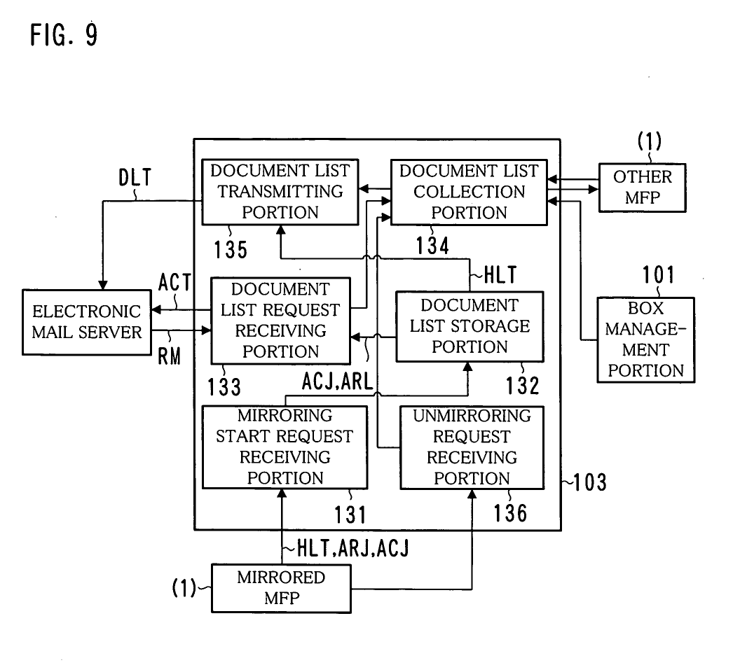

Referring to FIG. 9, the mirroring MFP processing portion 103 shown in FIG. 4 includes a mirroring start request receiving portion 131, a document list storage portion 132, a document list request receiving portion 133, a document list collection portion 134, a document list transmitting portion 135 and an unmirroring request receiving portion 136. The mirroring MFP processing portion 103 performs mirroring for other image forming device 1. The following is a description of processing contents of each of the portions included in the mirroring MFP processing portion 103, along with processing contents of the mirroring start requesting portion 125 and the unmirroring requesting portion 126 included in the home MFP processing portion 102 described earlier.

The mirroring start request receiving portion 131 performs processing for receiving a request to perform mirroring for another image forming device 1 belonging to the same segment SG from the other image forming device 1.

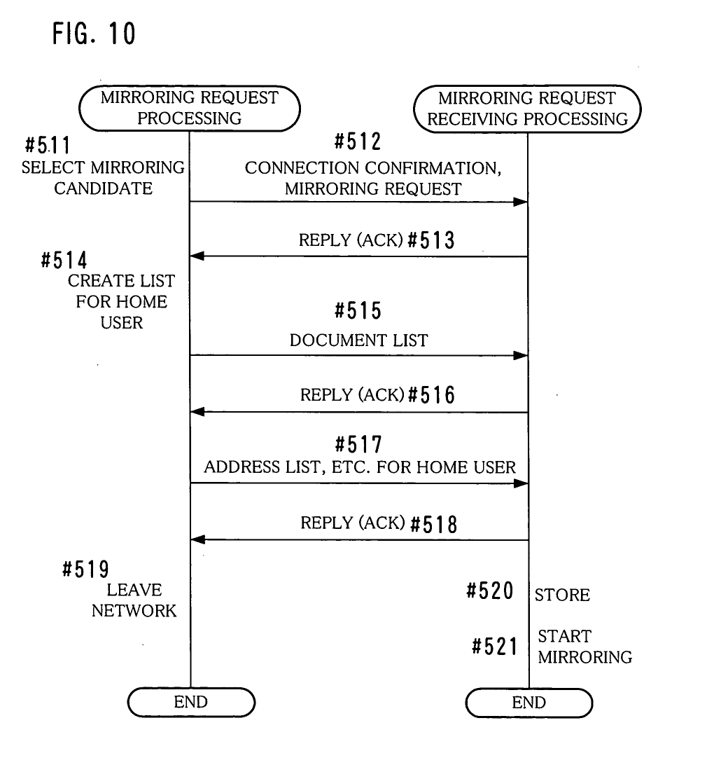

Herein, with reference to the flowchart of FIG. 10, the processing flow of each of the mirroring start requesting portion 125 and the mirroring start request receiving portion 131 is described, by way of example, when the image forming device 1AA belonging to the segment SGA makes a request for mirroring to the image forming device 1AB.

The mirroring start requesting portion 125 of the image forming device 1AA selects one image forming device 1 for which mirroring is requested from among other image forming devices 1 belonging to the same segment SGA (#511 in FIG. 10). For example, an image forming device 1 having the best specifications is selected. Herein, suppose that the image forming device 1AB has been selected. The mirroring start requesting portion 125 performs connection confirmation for the selected image forming device 1AB to request the same to perform mirroring for the image forming device 1AA (#512).

When receiving the request from the image forming device 1AA, the mirroring start request receiving portion 131 of the image forming device 1AB determines whether or not the request is acceptable based on situations including the current availability of the CPU 10a and the usage rate of the RAM 10b of the image forming device 1AB itself. If the request is acceptable, the mirroring start request receiving portion 131 responds to the image forming device 1AA accordingly (#513).

Responding to this, the mirroring start requesting portion 125 of the image forming device 1AA creates a saved document list HLT for each user UR who registers the image forming device 1AA as a home MFP, namely, for each home user URH for the image forming device 1AA (#514). The saved document list HLT includes attribute information (a data name, a path name of a box BX as a storage location, a data size and a data type) of document data DT saved in a local box BX of the home user URH.

The mirroring start requesting portion 125 of the image forming device 1AA and the mirroring start request receiving portion 131 of the image forming device 1AB perform communications processing so that these saved document lists HLT are sent from the former to the latter (#515 and #516). Further, they also perform communications processing so that the account information ACJ and the address list ARL stored in the account information storage portion 121 of the image forming device 1AA are sent from the former to the latter (#517 and #518).

When the processing described above is completed, the image forming device 1AA leaves the intranet NW (#519).

Meanwhile, the mirroring start request receiving portion 131 of the image forming device 1AB lets the document list storage portion 132 store the received saved document lists HLT, account information ACJ and address list ARL in association with identification information, e.g., a device name of the transmission source, i.e., the image forming device 1AA (#520). Then, the mirroring start request receiving portion 131 instructs the document list request receiving portion 133 to start mirroring (#521).

Hereinafter, an image forming device 1 that receives a mirroring request from other image forming device 1 to perform mirroring, like the image forming device 1AB described in the above example, is sometimes referred to as a “mirroring MFP”. In addition, an image forming device 1 that requests for mirroring to other image forming device 1, like the image forming device 1AA in the above example, is sometimes referred to as a “mirrored MFP”.

Referring back to FIG. 9, the document list storage portion 132 stores, as described above, the saved document lists HLT, the account information ACJ and the address list ARL all of which are received from the mirrored MFP.

The document list request receiving portion 133, the document list collection portion 134 and the document list transmitting portion 135 perform mirroring for the mirrored MFP. In other words, they perform processing which should be carried out normally by the document list request receiving portion 122, the document list collection portion 123 and the document list transmitting portion 124 (see FIG. 6) of the mirrored MFP, i.e., processing for providing a document data list DLT on behalf thereof.

When receiving the instructions from the mirroring start request receiving portion 131, the document list request receiving portion 133 starts processing for receiving a request for a document data list DLT from a user UR registering the mirrored MFP as a home MFP. The processing is performed according to the following procedure.

The user UR registering the mirrored MFP as a home MFP can perform operations similar to those described earlier to request a document data list DLT regardless of whether or not the mirrored MFP currently joins the intranet NW. More specifically, the user UR can use his/her terminal 2 to create a list request mail RM, use his/her terminal electronic mail address as a sender and send the list request mail RM to his/her second electronic mail address.

Responding to this, the electronic mail server EMS managing the second electronic mail account of the second electronic mail address, as described earlier, receives the list request mail RM to store the same in an in-box corresponding to the second electronic mail account.

The document list request receiving portion 133, in place of the document list request receiving portion 122 of the mirrored MFP, regularly accesses the electronic mail server EMS to check whether or not a list request mail RM is received to the second electronic mail address of each home user URH of the mirrored MFP. If the list request mail RM is received, the document list request receiving portion 133 obtains the same. Note that the account information ACJ of the mirrored MFP stored in the document list storage portion 132 is used in order to check and obtain the list request mail RM.

The document list request receiving portion 133 accepts the obtained list request mail RM as a request from the user UR having the second electronic mail address indicated in the destination of the obtained mail RM. The document list request receiving portion 133, then, instructs the document list collection portion 134 and the document list transmitting portion 135 to perform processing for responding to the request. However, when a sender (a transmission source) of the list request mail RM is not a home user URH for the mirrored MFP, the document list request receiving portion 133 denies the request regarding the list request mail RM to send a message indicating that the request is unacceptable. It can be decided whether or not the sender of the list request mail RM is a home user URH for the mirrored MFP based on the address list ARL for the mirrored MFP stored in the document list storage portion 132.

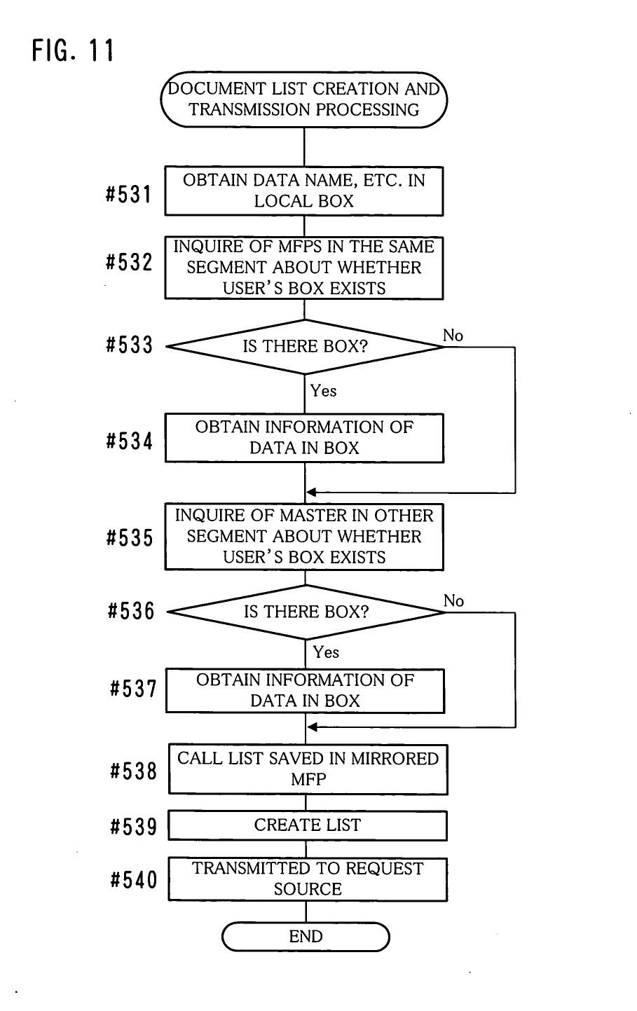

By following the instructions from the document list request receiving portion 133, the document list collection portion 134 and the document list transmitting portion 135 perform processing for creating a document data list DLT for the user UR regarding the sender of the list request mail RM (the home user URH for the mirrored MFP) to transmit the same to the sender according to the procedure shown in FIG. 11. Since the procedure shown in FIG. 11 partly overlaps the procedure shown in FIG. 7, the description of the overlapping points is omitted.

Suppose, for example, that the document list request receiving portion 133 has received a list request mail RM from the user UR2 who registers the mirrored MFP as a home MFP.

The document list collection portion 134 refers to a box BX, which is managed by the box management portion 101 of that image forming device 1 itself, of the user UR2 who is a sender of the list request mail RM. Then, the document list collection portion 134 obtains attribute information of each piece of document data DT saved in the box BX (#531 in FIG. 11).

In parallel with this or before or after, the document list collection portion 134 obtains, from other image forming devices 1 belonging to the same segment SG, attribute information of each piece of document data DT saved in the box BX of the user UR2 managed by the box management portion 101 of each of the other image forming devices 1 (#532 to #534). This processing is basically the same as that described earlier in Steps #502 to #504 shown in FIG. 7. Note, however, that this processing is unnecessary for the mirrored MFP.

In parallel with the processing in Step #531 and the processing from Steps #532 to #534 or before or after the same, the document list collection portion 134 obtains, from a segment master of other segment SG, attribute information of each piece of document data DT saved in the box BX of the user UR2 managed by the box management portion 101 of the image forming device 1 belonging to the other segment SG (#535 to #537). This processing is similar to that described earlier in Steps #505 to #507 shown in FIG. 7. The specific processing contents in the segment master are described later.

In parallel with the processing in Step #531, the processing from Steps #532 to #534 and the processing from Steps #535 to #537 or before or after the same, the document list collection portion 134 calls the saved document list HTL for the user UR2 stored in the document list storage portion 132 (#538). Stated differently, the document list collection portion 134 retrieves a list of each piece of the document data DT saved in the box BX of the user UR2 managed by the box management portion 101 of the mirrored MFP.

The information obtained or retrieved in Steps #531, #534, #537 and #538 is organized. Thereby, a document data list DLT is created that indicates the document data DT saved in the box BX of the user UR2 managed by each of the image forming devices 1 in the document data list browsing system DLS (#539).

The document list transmitting portion 135 transmits a list attached mail LM to which the created document data list DLT is attached to a terminal electronic mail address of the user UR2 who is the request source (#540).

The user UR2 uses his/her terminal 2 to receive and open the list attached mail LM, as in the case where his/her home MFP joins the intranet NW. Then, as shown in FIG. 8, on the display of the terminal 2 is displayed the document data list screen HG1 similarly to the case where his/her home MFP joins the intranet NW.

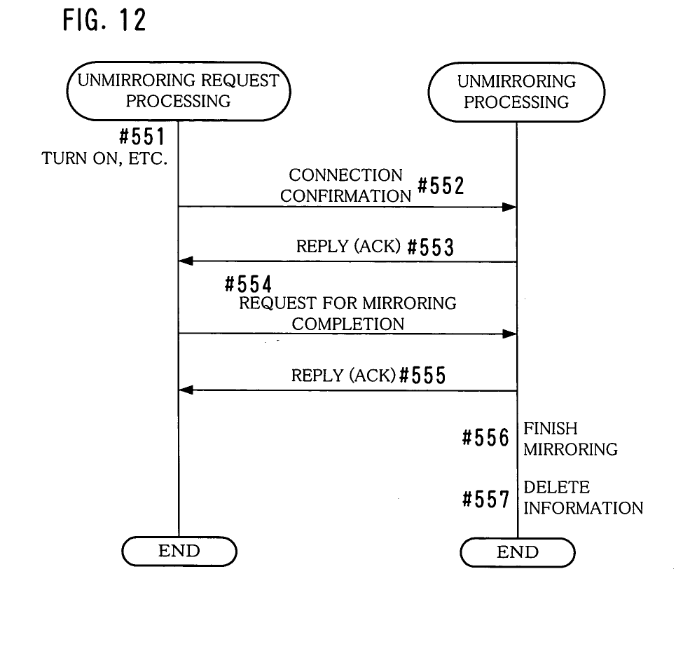

The unmirroring requesting portion 126 shown in FIG. 6 requests a mirroring MFP for the image forming device 1 itself to stop (cancel) the mirroring. The unmirroring request receiving portion 136 of the mirroring MFP shown in FIG. 9 performs processing for accepting such a request. Herein, with reference to the flowchart of FIG. 12, the processing flow of each of the unmirroring requesting portion 126 and the unmirroring request receiving portion 136 is described, by way of example, when the image forming device 1AA that is currently the mirrored MFP makes a request for unmirroring to the image forming device 1AB functioning as the mirroring MFP for the image forming device 1AA.

In the image forming device 1AA, events like power-on operation and network initialization occur and entry into the intranet NW is restarted (#551 in FIG. 12), the unmirroring requesting portion 126 performs connection confirmation for the mirroring MFP for the image forming device 1AA, namely, the image forming device 1AB (#552). When a response is made from the image forming device 1AB (#553), the unmirroring requesting portion 126 requests the image forming device 1AB to stop the mirroring (#554).

Responding to this, the unmirroring request receiving portion 136 of the image forming device 1AB informs the image forming device 1AA that the request is accepted (#555) and instructs the document list request receiving portion 133 to finish (stop) the mirroring for the image forming device 1AA that is the request source (#556). Then, the saved document list HLT, the account information ACJ and the address list ARL relating to the image forming device 1AA are deleted from the document list storage portion 132 (#557).

Referring to FIG. 13, the segment master processing portion 104 shown in FIG. 4 includes a document information request receiving portion 141, a document information collection portion 142 and a document information transmitting portion 143. The segment master processing portion 104 performs processing for providing information of document data DT saved in a box BX managed by that image forming device 1 itself and information of document data DT saved in a box BX managed by other image forming device 1 belonging to the same segment SG depending on a request from an image forming device 1 belonging to other segment SG.

The document information request receiving portion 141 receives a request from the image forming device 1 belonging to the other segment SG to instruct the document information collection portion 142 and the document information transmitting portion 143 to provide the image forming device 1 with information of document data DT that are exactly requested.

The document information collection portion 142 collects information of document data DT that are saved in boxes BX of a user UR specified in the request. The boxes BX are managed by the box management portion 101 of that image forming device 1 itself and by the box management portion 101 of other image forming device 1 belonging to the same segment SG, respectively.

The document information transmitting portion 143 sends the image forming device 1 that is the request source the information collected by the document information collection portion 142 as a document list DCJ.

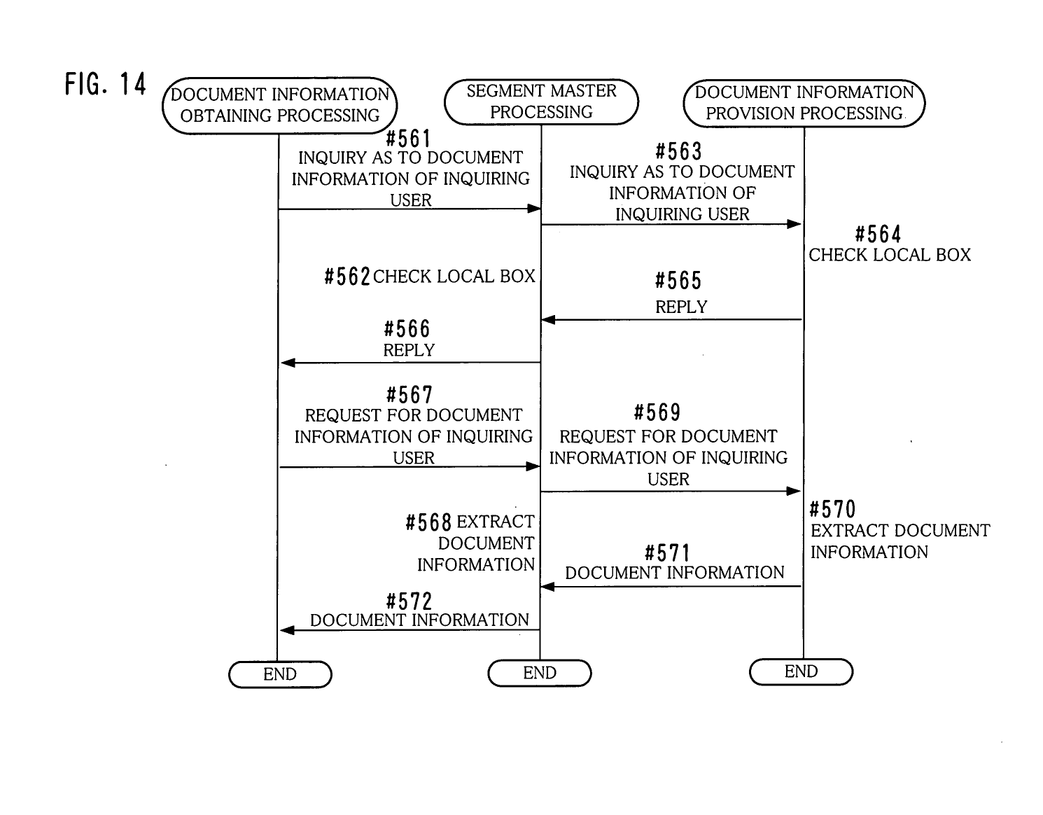

Herein, with reference to the flowchart of FIG. 14, the processing flow of the document information request receiving portion 141 through the document information transmitting portion 143 is described, by way of example, when a request is made from the image forming device 1AA belonging to the segment SGA to the image forming device 1BA that is a segment master of the segment SGB.

For example, when receiving a list request mail RM from the user UR3, in order to create a document data list DTL for the user UR3, the image forming device 1AA inquires of segment masters of segments SG other than the segment SG to which the image forming device 1AA belongs, i.e., a segment master of each of the segment SGB, the segment SGC . . . whether or not a box BX of the user UR3 exists (#561 in FIG. 14). This inquiry processing corresponds to the processing of Step #505 described earlier with reference to FIG. 7 and the processing of Step #535 described with reference to FIG. 11.

When accepting such an inquiry, the document information request receiving portion 141 of the image forming device 1BA that is a segment master of the segment SGB checks whether or not the box management portion 101 of that image forming device 1BA manages a box BX of the user UR3 (#562). The document information request receiving portion 141 further inquires of other image forming devices 1 (1BB, 1BC . . . ) belonging to the same segment SGB whether or not they manage a box BX of the user UR3 each (#563). The image forming devices 1BB, 1BC, . . . check whether or not their own box management portions 101 manage a box BX of the user UR3 each (#564) to notify the image forming device 1BA of the respective check results (#565).

The image forming device 1BA sends the respective check results of Steps #562 and #564 to the image forming device 1AA that is the inquiry source, i.e., replies to the inquiry (#566).

When receiving a reply indicating that any of the image forming devices 1 belonging to the other segments SG manage a box BX of the user UR3, the image forming device 1AA requests for information of document data DT saved in the box BX to the segment master of the segment SG (#567). Herein, suppose, for example, that the box BX of the user UR3 is managed in an image forming device 1 belonging to the segment SGB. Accordingly, the image forming device 1AA makes the request to the image forming device 1BA (#567).

In the image forming device 1BA, when the document information request receiving portion 141 accepts such a request, the document information collection portion 142 extracts information of document data DT saved in the box BX, provided that the box BX of the user UR3 is managed in the image forming device 1BA (#568). If the box BX of the user UR3 is managed in the other image forming devices 1 (1BB, 1BC, . . . ), the other image forming devices 1 are requested to send information of document data DT saved in the box BX of the user UR3 (#569).

Responding to this request, the image forming devices 1 (1BB, 1BC, . . . ) extract the information of the document data DT saved in the box BX managed therein (#570) to send the extracted information to the image forming device 1BA (#571).

The document information transmitting portion 143 of the image forming device 1BA organizes the information of the document data DT thus obtained to send the same as a document list DCJ to the image forming device 1AA that is the request source (#572).

When functioning as a mirroring MFP for the other image forming device belonging to the segment SGB, the image forming device 1BA extracts the information of the document data DT saved in the box BX of the user UR3 managed in the other image forming device, i.e., a mirrored MFP, to include the extracted information in the document list DCJ.

Similarly, when the image forming device 1BB, 1BC, or . . . functions as a mirroring MFP for other image forming device 1, the image forming device 1BB, 1BC, or . . . extracts information of document data DT saved in the box BX of the user UR3 managed in the other image forming device 1 to send the extracted information to the image forming device 1BA, i.e., replies thereto.

The processing in Steps #567 and #572, namely, the processing that the image forming device 1AA requests and obtains information from the image forming device 1BA corresponds to the processing in Step #507 described earlier with reference to FIG. 7 and the processing in Step #537 described with reference to FIG. 11.

As described earlier with reference to FIGS. 7 and 11, the image forming device 1AA uses the document list DCJ obtained from the image forming device 1BA to create a document data list DLT for the user UR3 that is a sender of the list request mail RM. The image forming device 1AA is a home MFP for the user UR3 in some cases, while it is a mirroring MFP for the home MFP of the user UR3 in other cases.

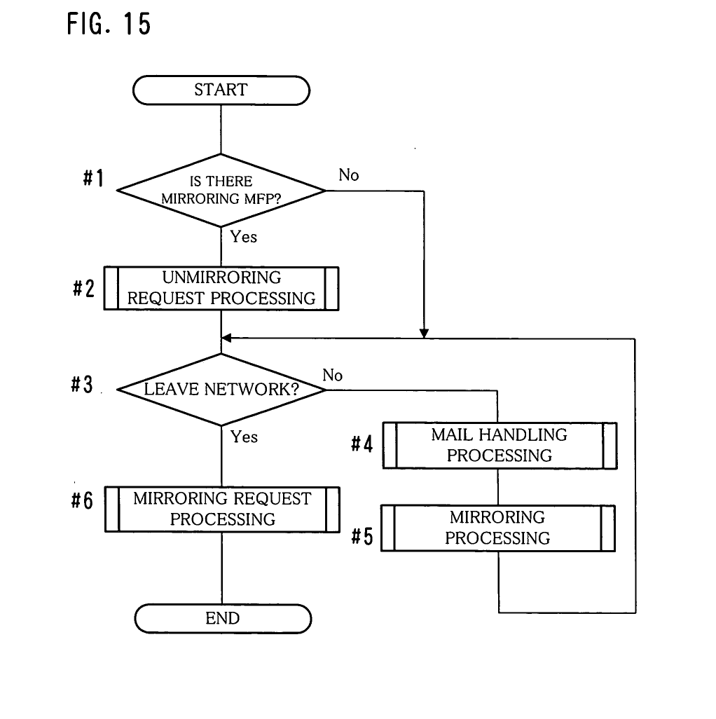

Next, a description is provided, with reference to flowcharts shown in FIGS. 15-18, of processing flow when the image forming device 1 is used in various roles.

Referring to FIG. 15, in the case where the image forming device 1 starts or restarts to participate in the intranet NW, if other image forming device 1 functions as a mirroring MFP for that image forming device 1 (Yes in #1), the image forming device 1 performs processing for requesting the other image forming device 1 to stop the mirroring processing, i.e., performs the unmirroring request processing (#2). This processing procedure is as described above with reference to FIG. 12.

While participating in the intranet NW (No in #3), the image forming device 1 functions as a home MFP for a specific user UR, and, also functions as a mirroring MFP for other image forming device 1 that let the intranet NW. Stated differently, the image forming device 1 performs processing for handling a list request mail RM from a home user URH and an electronic mail to be delivered to the home user URH, i.e., performs the mail handling processing (#4). In addition, the image forming device 1 performs, in place of the other image forming device 1 that left the intranet NW, processing for functioning as a home MFP for the home user URH of the other image forming device 1, i.e., performs the mirroring processing (#5). There is no execution order relationship between the processing in Steps #4 and #5. Both the processing is performed appropriately and is sometimes performed in parallel with each other.

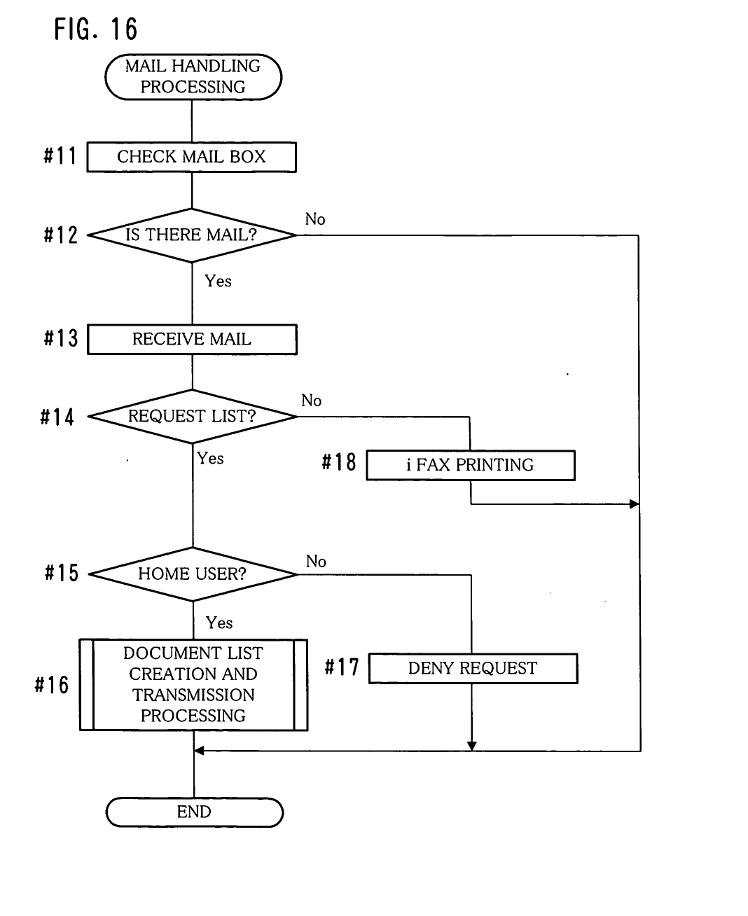

The procedure of the mail handling processing in Step #4 is exactly as shown in FIG. 16. More specifically, the image forming device 1 regularly accesses the electronic mail server EMS belonging to the same segment SG to check whether or not a new electronic mail is delivered to an in-box of the first electronic mail account of each home user URH and an in-box of the second electronic mail account of each home user URH (#11 in FIG. 16).

When an electronic mail is delivered in the in-box (Yes in #12), the image forming device 1 receives the same (#13). If the electronic mail is a list request mail RM (Yes in #14), it is checked whether or not a sender of the electronic mail is a home user URH of that image forming device 1. Then, when the sender is a home user URH (Yes in #15), the image forming device 1 performs processing for creating a document data list DLT for the sender to send the same, i.e., performs the document list creation and transmission processing (#16). This processing procedure is as described above with reference to FIG. 7. As a result of this processing, the document data list screen HG1 as shown in FIG. 8 is displayed in the terminal 2 of the sender. In contrast, when the sender of the list request mail RM is not a home user URH (No in #15), the image forming device 1 denies a request regarding the list request mail RM to send a message indicating the denial to the sender (#17).

If the received electronic mail is one delivered to the first electronic mail address (No in #14), the electronic mail is used for printing a document (#18). In short, iFAX reception processing is performed as before. Note that, instead of the printing, the electronic mail may be saved in a box BX of a home user URH specified in the destination of the electronic mail.

The received electronic mail may be deleted from the in-box after performing any of the processing shown in Steps #16, #17 and #18.

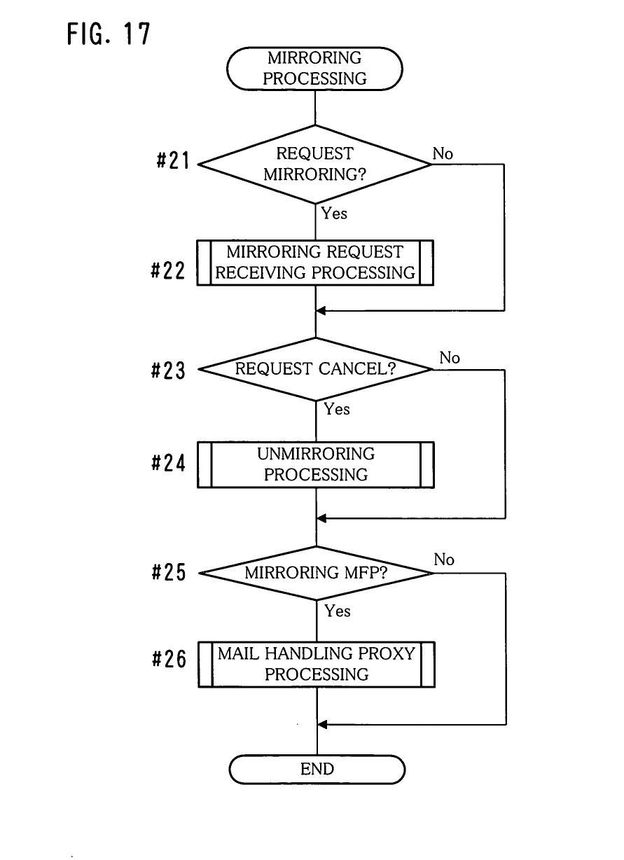

Meanwhile, the mirroring processing procedure in Step #5 shown in FIG. 15 is exactly as shown in FIG. 17. When a mirroring request is made from other image forming device 1 (Yes in #21), the image forming device 1 accepts the request to perform preparation processing for becoming a mirroring MFP for the other image forming device 1, i.e., performs the mirroring request reception processing (#22). This processing procedure is as described above with reference to FIG. 10.

When the image forming device 1 functions as a mirroring MFP for other image forming device 1 and receives a mirroring cancel (finish) request from that other image forming device 1 (Yes in #23), the image forming device 1 performs processing for canceling the function as the mirroring MFP for the other image forming device 1, i.e., performs the unmirroring processing (#24). This processing procedure is as described above with reference to FIG. 12.

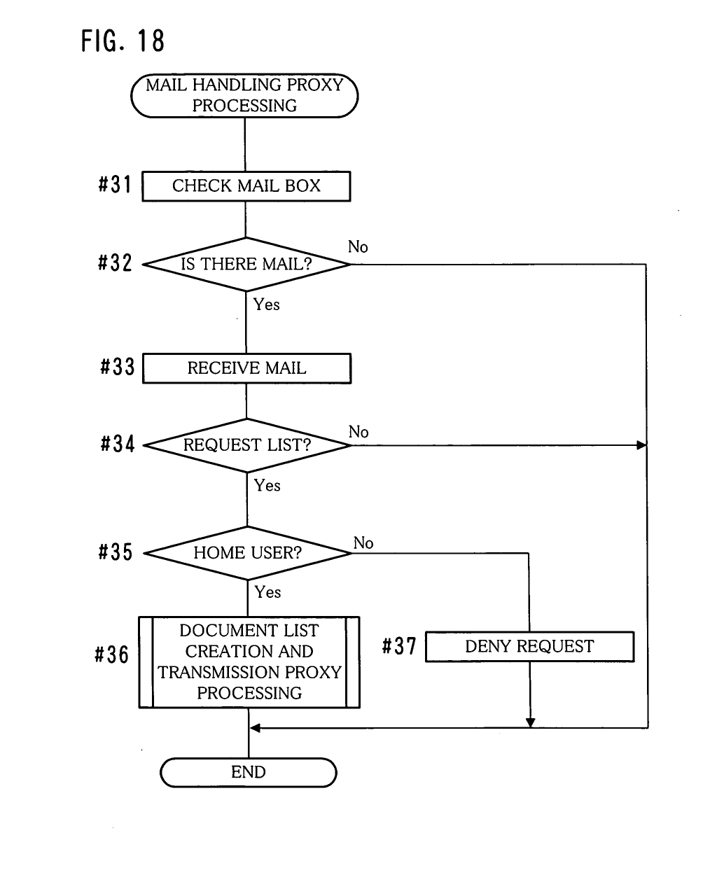

Further, when the image forming device 1 functions as a mirroring MFP for other image forming device 1 (a mirrored MFP) (Yes in #25), the image forming device 1 performs, in place of the mirrored MFP, processing for handling a list request mail RM from a home user URH of the mirrored MFP and an electronic mail to be delivered to the home user URH, i.e., performs the mail handling proxy processing. This processing procedure is exactly as shown in FIG. 18.

More specifically, the image forming device 1 regularly accesses the electronic mail server EMS to check whether or not a new electronic mail is delivered to an in-box of the first electronic mail account of each home user URH of the mirrored MFP and an in-box of the second electronic mail account of each home user URH of the mirrored MFP (#31 in FIG. 18).

When an electronic mail is delivered to the in-box (Yes in #32), the image forming device 1 receives the same (#33). If the electronic mail is a list request mail RM (Yes in #34), it is checked whether or not a sender of the list request mail RM is a home user URH of the mirrored MFP. Then, when the sender is a home user URH of the mirrored MFP (Yes in #35), the image forming device 1 performs, in place of the mirrored MFP, processing for creating a document data list DLT for the sender to send the same, i.e., performs the document list creation and transmission proxy processing (#36). This processing procedure is as described above with reference to FIG. 11. As a result of this processing, the document data list screen HG1 as shown in FIG. 8 is displayed in the terminal 2 of the sender. In contrast, when the sender of the list request mail RM is not a home user URH of the mirrored MFP (No in #35), the image forming device 1 denies a request regarding the list request mail RM to send a message indicating the denial to the sender (#37). The received list request mail RM may be deleted from the in-box.

If the received electronic mail is one delivered to the first electronic mail address, namely, one delivered to an iFAX electronic mail address (No in #34), the electronic mail is caused to remain in the in-box and processing such as printing is not performed, unlike the case of the mail handling processing described with reference to FIG. 16.

Referring back to FIG. 15, when the image forming device 1 has to leave the intranet NW due to the necessity of turning off the power supply or other reasons (Yes in #3), the image forming device 1 performs processing for having other image forming device 1 belonging to the same segment SG function as a mirroring MFP, i.e., performs the mirroring request processing (#6). This processing procedure is as described above with reference to FIG. 10.

After leaving the intranet NW, when the image forming device 1 rejoins the intranet NW, the image forming device 1 performs the processing again from Step #1 shown in FIG. 15. More specifically, the image forming device 1 releases the mirroring MFP that has been set by performing the unmirroring processing (#2). Then, the image forming device 1 performs the mail handling processing and the mirroring processing timely (#4 and #5).

In addition, while joining the intranet NW, the image forming device 1 provides information on document data DT saved in a box BX managed therein in accordance with a request from other image forming device 1. Further, when the image forming device 1 is a segment master of the segment SG to which it belongs, the image forming device 1 performs the segment master processing described with reference to FIG. 14.

In this embodiment, a user UR can easily confirm what kind of document data are saved in each of the image forming devices 1 constituting the document data list browsing system DLS. Besides, the confirmation is easily possible even the state where an image forming device 1 primarily used by himself/herself leaves the intranet NW. Devises inside and outside the intranet NW exchange information using an electronic mail protocol. Accordingly, a user can use his/her terminal 2 to make the confirmation easily even when he/she is outside the office.

In this embodiment, there are separately prepared an electronic mail account for iFAX (the first electronic mail account) and an electronic mail account for request for a document data list DLT (the second electronic mail account). However, one electronic mail account may be used for both the purposes. In such a case, a user UR writes an electronic mail title (subject) or a text in a different manner depending on the purpose. For example, when making a request for a document data list DLT, the user UR types a title such as a “list request” in an electronic mail. Then, the image forming device 1 determines that an electronic mail titled “list request” is a list request mail RM.

In this embodiment, when a list request mail RM is received from a user UR, a list is provided of document data DT saved in user's own box BX. Instead, a configuration may be adopted in which document data DT meeting requirements specified by the user UR is searched and a list thereof is provided.

According to this embodiment, a home MFP or a mirroring MFP collects information of document data DT saved in a box BX of a user UR and provides the user UR with a document data list DLT in which the collected information is organized. It is possible, however, to collect information of document data DT for each segment SG to provide a list in which the collected information is organized. For instance, when a request is made from a user UR who registers an image forming device 1 belonging to the segment SGA as a home MFP, the home MFP (or a mirroring MFP therefor) may create a list of document data DT saved in a box BX managed in each image forming device 1 belonging to the segment SGA and provide the user UR with the list. Then, a segment master of each segment SG may create a list of document data DT saved in a box BX managed in each image forming device 1 belonging to other segment SG and provide the user with the list. Further, each image forming device 1 may individually create a list of document data DT saved in a box BX managed therein and provide a user UR with the list.

In this embodiment, an electronic mail server EMS is provided for each segment SG. Instead, however, plural segments SG may share one electronic mail server EMS.

The document data list DLT may be provided in the form of binary data corresponding to application such as database software or spreadsheet software or in the form of text data such as a Comma Separated Value (CSV). The document data list DLT may be provided also in the form of image data such as a bitmap image or a TIFF image. The same applies to the saved document list HLT, the document list DCJ and the address list ARL.

Further, the document data list DLT may be provided in each segment SG that is a storage location or in each terminal 2 that is a storage location in a distributed manner.

In the embodiments described above, the overall configuration of the document data list browsing system DLS, the intranet NW and the image forming device 1, the configurations of various portions thereof, the details of processing, the processing order, and the like may be changed as needed, in accordance with the subject matter of the present invention.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A document data processing device performing processing related to document data, the device comprising:
a data saving portion for saving the document data;
a list request receiving portion for receiving a request for a list of the document data; and
a list providing portion for performing list provision processing for providing a user who has made the request with a first list and a second list based on the request received by the list request receiving portion, the first list being a list of the document data saved in the data saving portion and the second list being a list of document data saved in other document data processing device.

2. The document data processing device according to claim 1, wherein the list providing portion performs the list provision processing by receiving, from the other document data processing device, information of the document data saved in the other document data processing device and by sending the first list and the second list including the information thus received to the user who has made the request.

3. The document data processing device according to claim 1, wherein the list providing portion performs the list provision processing by sending the first list from the document data processing device itself to the user who has made the request and by letting the other document data processing device send the second list to the user who has made the request.

4. The document data processing device according to claim 1,
wherein
the data saving portion is provided with a storage area for saving the document data for each user, and
the list providing portion performs the list provision processing so as to provide the user who has made the request with the first list of the document data saved in the storage area of the user who has made the request and the second list of document data saved in a storage area, provided in the other document data processing device, of the user who has made the request.

5. A document data processing device performing processing related to document data, the device comprising:
a data saving portion for saving the document data of a first user who is a user primarily using the document data processing device;
a list request receiving portion for receiving a request for a list of the document data from the first user;
a list providing portion for performing list provision processing for providing the first user who has made the request with a first list and a second list based on the request received by the list request receiving portion, the first list being a list of the document data saved in the data saving portion and the second list being a list of document data saved in other document data processing device;
a list request receiving proxy portion for receiving the request from a second user who is a user primarily using other document data processing device in place of the other document data processing device; and
a list provision proxy portion for performing list provision proxy processing, in place of the other document data processing device primarily used by the second user who has made the request, for providing the second user with a third list and a fourth list based on the request received by the list request receiving proxy portion, the third list being a list of the document data saved in the other document data processing device and the fourth list being a list of document data saved in a document data processing device except for the other document data processing device.

6. The document data processing device according to claim 5, wherein the list providing portion performs the list provision processing by receiving, from the other document data processing device, information of the document data saved in the other document data processing device and by sending the first list and the second list including the information thus received to the first user who has made the request.

7. The document data processing device according to claim 5, wherein the list providing portion performs the list provision processing by sending the first list from the document data processing device itself to the first user who has made the request and by letting the other document data processing device send the second list to the first user who has made the request.

8. The document data processing device according to claim 5,
wherein
the data saving portion is provided with a storage area for saving the document data for each of the first users, and
the list providing portion performs the list provision processing so as to provide the first user who has made the request with the first list of the document data saved in the storage area of the first user who has made the request and the second list of document data saved in a storage area, provided in the other document data processing device, of the first user who has made the request.

9. The document data processing device according to claim 5, further comprising
an other device saved data list obtaining portion for obtaining, from the other document data processing device that the second user uses primarily, an other device saved data list that is a list of the document data saved in the other document data processing device,
wherein the list provision proxy portion performs the list provision proxy processing based on the other device saved data list of the other document data processing device primarily used by the second user who has made the request.

10. The document data processing device according to claim 9, wherein the other device saved data list obtaining portion obtains, from the other document data processing device that the second user uses primarily, as the other device saved data list, the list of the document data saved in a storage area of the second user provided in the other document data processing device.

11. A document data list provision method for providing a list of document data saved in plural devices on a network, the method comprising:
making any of the devices on the network perform processing for receiving a request for the list of the document data; and
making any of the devices on the network perform processing for providing, based on the received request, a user who has made the request with the list of the document data saved in the device itself and a list of document data saved in other device.

12. A document data list provision method for providing a list of document data saved in plural devices on a network, the method comprising:
making any of the devices on the network perform processing for receiving a request for the list of the document data;
when the request is received from a user who uses the device primarily, making any of the devices on the network perform processing, based on the request, for providing the user who has made the request with the list of the document data saved in the device as well as a list of document data saved in other device; and
when the request is received from a user who uses the other device primarily, making any of the devices on the network perform processing, based on the request, for providing the user who has made the request with the list of the document data saved in the other device as well as a list of document data saved in a device except for the other device.

13. A computer program product for use in a computer that provides a list of document data saved in plural devices on a network, the computer program product letting the computer execute the processes comprising:
receiving a request for the list of the document data; and
providing, based on the received request, a user who has made the request with the list of the document data saved in the computer itself and a list of document data saved in other device.

14. A computer program product for use in a computer that provides a list of document data saved in plural devices on a network, the computer program product letting the computer execute the processes comprising:
receiving a request for the list of the document data;
when the request is received from a user who uses the computer primarily, making any of the devices on the network perform processing, based on the request, for providing the user who has made the request with the list of the document data saved in the computer as well as a list of document data saved in other device; and
when the request is received from a user who uses the other device primarily, making any of the devices on the network perform processing, based on the request, for providing the user who has made the request with the list of the document data saved in the other device as well as a list of document data saved in a device except for the other device.
